(19) United States
(12) Patent Application Publication
(10) Pub. No.: US 2026/0169182 A1
(43) Pub. Date: Jun. 18, 2026

(54) A METHOD OF DETERMINING A SMOOTH SEISMIC VELOCITY MODEL USING SHAPING REGULARIZATION AND KINEMATIC EQUIVALENCE

(71) Applicant: SAUDI ARABIAN OIL COMPANY, Dhahran (SA)

(72) Inventors: Yujin Liu, Beijing (CN); Yi He, Beijing (CN); Hongwei Liu, Dhahran (SA); Fuhao Qin, Dhahran (SA)

(73) Assignees: ARAMCO FAR EAST (BEIJING) BUSINESS SERVICES CO., LTD., Beijing (CN); SAUDI ARABIAN OIL COMPANY, Dhahran (SA)

(21) Appl. No.: 18/718,244

(22) PCT Filed: Aug. 25, 2023
(86) PCT No.: PCT/CN2023/114990

§ 371 Date: Jun. 10, 2024

(51) Int. Cl. G01V 1/30; E21B 41/00; E21B 49/00; G01V 1/28; G01V 1/34

(52) U.S. Cl. CPC G01V 1/301; E21B 41/00; E21B 49/00; G01V 1/282; G01V 1/303; G01V 1/345; E21B 2200/20; G01V 2210/51

(57) ABSTRACT

A method may include obtaining seismic data and first predicted traveltimes from a subterranean region of interest and initializing a smooth seismic velocity model. The methods may further include, iteratively or recursively, until a convergence criterion is satisfied, determining an updated smooth seismic velocity model by determining second predicted traveltimes from the smooth seismic velocity model, forming a cost function based, at least in part, on the first predicted traveltimes and the second predicted traveltimes, determining an extremum of the cost function, and perturbing the smooth seismic velocity model based on the extremum. The methods may still further include determining a migrated seismic image using, at least in part, the seismic data and the updated smooth seismic velocity model and determining a location of a hydrocarbon reservoir within the subterranean region of interest using, at least in part, the migrated seismic image.

### BACKGROUND

Seismic processing is a series of steps designed to alter raw seismic data collected for a subterranean region of interest. The processed seismic data, typically in the form of a seismic image, may then be immediately used to characterize and locate structural features, such as hydrocarbon reservoirs, within the subterranean region of interest. One or more seismic processing steps may correct for near-surface effects, suppress noise, correct for seismic survey geometry irregularities, enhance signal-to-noise ratio, migrate seismic events, convert between domains, etc.

If the seismic events within the seismic data are manifestations of complex structural features within the subterranean region of interest, the processing step of migration may be performed. Migration may aim to relocate the seismic events within the raw or partially processed seismic data such that the seismic events correspond to the true locations of the complex structural features within the subterranean region of interest.

Migration may use a seismic velocity model. As such, the seismic velocity model affects the migration results. For example, an irregularly-sampled and discontinuous seismic velocity model or poorly smoothed seismic velocity model may lead to error in the seismic image such that the seismic events do not correspond to the true locations of the complex structural features within the subterranean region of interest.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In general, in one aspect, embodiments relate to a method. The method includes obtaining seismic data and first predicted traveltimes from a subterranean region of interest and initializing a smooth seismic velocity model. The method further includes, iteratively or recursively, until a convergence criterion is satisfied, determining an updated smooth seismic velocity model by determining second predicted traveltimes from the smooth seismic velocity model, forming a cost function based, at least in part, on the first predicted traveltimes and the second predicted traveltimes, determining an extremum of the cost function, and perturbing the smooth seismic velocity model based on the extremum. The method still further includes determining a migrated seismic image using, at least in part, the seismic data and the updated smooth seismic velocity model and determining a location of a hydrocarbon reservoir within the subterranean region of interest using, at least in part, the migrated seismic image.

In general, in one aspect, embodiments relate to a system. The system includes a seismic processing system and a seismic interpretation workstation. The seismic processing system is configured to receive seismic data and first predicted traveltimes from a subterranean region of interest and initialize a smooth seismic velocity model. The seismic processing system is further configured to, iteratively or recursively, until a convergence criterion is satisfied, determine an updated smooth seismic velocity model by determining second predicted traveltimes from the smooth seismic velocity model, forming a cost function based, at least in part, on the first predicted traveltimes and the second predicted traveltimes, determining an extremum of the cost function, and perturbing the smooth seismic velocity model based on the extremum. The seismic processing system is still further configured to determine a migrated seismic image using, at least in part, the seismic data and the updated smooth seismic velocity model. The seismic interpretation workstation is configured to determine a location of a hydrocarbon reservoir within the subterranean region of interest using, at least in part, the migrated seismic image.

In general, in one aspect, embodiments relate to a non-transitory computer-readable memory having computer-executable instructions stored thereon that, when executed by a computer processor, perform steps. The steps include receiving seismic data and first predicted traveltimes from a subterranean region of interest and initializing a smooth seismic velocity model. The steps further include, iteratively or recursively, until a convergence criterion is satisfied, determining an updated smooth seismic velocity model by determining second predicted traveltimes from the smooth seismic velocity model, forming a cost function based, at least in part, on the first predicted traveltimes and the second predicted traveltimes, determining an extremum of the cost function, and perturbing the smooth seismic velocity model based on the extremum. The steps still further include determining a migrated seismic image using, at least in part, the seismic data and the updated smooth seismic velocity model and determining a location of a hydrocarbon reservoir within the subterranean region of interest using, at least in part, the migrated seismic image.

Other aspects and advantages of the claimed subject matter will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency.

FIG. 1 illustrates a surface seismic survey in accordance with one or more embodiments.

FIGS. 2A and 2B display one-dimensional seismic velocity models in accordance with one or more embodiments.

FIGS. 3A and 3B display one-dimensional migrated seismic images in accordance with one or more embodiments.

FIGS. 4A-4C display two-dimensional migrated seismic images in accordance with one or more embodiments.

FIGS. 5A-5C display two-dimensional migrated seismic images in accordance with one or more embodiments.

FIGS. 6A and 6B show flowcharts in accordance with one or more embodiments.

FIG. 7 illustrates a computer system in accordance with one or more embodiments.

FIG. 8 illustrates a drilling system in accordance with one or more embodiments.

FIG. 9 shows systems in accordance with one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before,” “after,” “single,” and other such terminology. Rather, the use of ordinal numbers is to distinguish between the elements. By way of an example, a first element is distinct from a second element, and the first element may encompass more than one element and succeed (or precede) the second element in an ordering of elements.

It is to be understood that the singular forms “a,” “an,” and “the” include plural referents unless the context clearly dictates otherwise. Thus, for example, reference to “a cost function” includes reference to one or more of such functions.

Terms such as “approximately,” “substantially,” etc., mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

It is to be understood that one or more of the steps shown in the flowcharts may be omitted, repeated, and/or performed in a different order than the order shown. Accordingly, the scope disclosed herein should not be considered limited to the specific arrangement of steps shown in the flowcharts.

Although multiple dependent claims are not introduced, it would be apparent to one of ordinary skill that the subject matter of the dependent claims of one or more embodiments may be combined with other dependent claims.

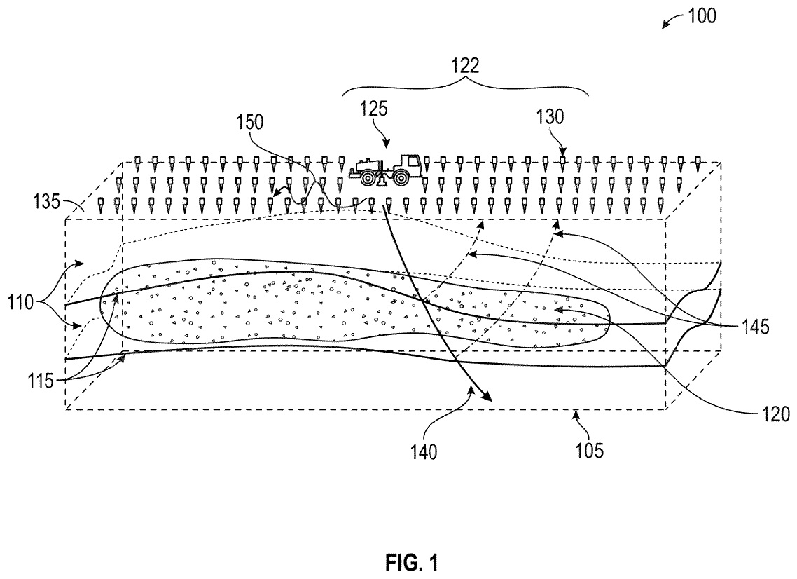

In the following description of FIGS. 1-9, any component described regarding a figure, in various embodiments disclosed herein, may be equivalent to one or more like-named components described regarding any other figure. For brevity, descriptions of these components will not be repeated regarding each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment which may be implemented in addition to, in conjunction with, or in place of the embodiments described regarding a corresponding like-named component in any other figure.

Methods and systems are disclosed to determine a smooth seismic velocity model from first predicted traveltimes. Methods may include using shaping regularization and the concept of kinematic equivalence within seismic inversion. The smooth seismic velocity model may be used, at least in part, to determine a migrated seismic image with adequately relocated seismic events.

In the context of this disclosure, seismic inversion (hereinafter “inversion”) may be the iterative process of determining the smooth seismic velocity model based on a cost function. The cost function may be formed between predicted traveltimes determined from a seismic survey (hereinafter “first predicted traveltimes”) and predicted traveltimes determined from the smooth seismic velocity model (hereinafter “second predicted traveltimes”). Iterative minimization of the cost function such that the second predicted traveltimes approach the first predicted traveltimes may result in the smooth seismic velocity model being considered kinematically equivalent to a seismic velocity model determined from the first predicted traveltimes. Further, the cost function may use shaping regularization by including a shaping operator.

The disclosed methods may be considered an improvement over conventional methods used to determine a smooth seismic velocity model for at least one of the following reasons. One reason is that the shaping operator is flexible. That is, a variety of static and dynamic (i.e., nonstationary) shaping operators may be used within the disclosed methods. A flexible shaping operator may better control the smooth seismic velocity model and do so in fewer iterations compared to conventional methods that may not use a shaping operator. Another reason is that the disclosed methods may be constrained by local structural features within the subterranean region of interest by using a dynamic structure-oriented shaping operator. Yet another reason is that the disclosed methods are constrained or further constrained by the first predicted traveltimes. As such, one goal of the disclosed methods is to preserve the second predicted traveltimes relative to the first predicted traveltimes using the concept of kinematic equivalence. Preserving the second predicted traveltimes, in turn, preserves each depth associated with each first predicted traveltime. Other conventional methods that do not aim to preserve predicted traveltimes may poorly determine a smooth seismic velocity model at locations where discontinuities exist within the seismic velocity model determined from the first predicted traveltimes.

The first predicted traveltimes may be collected during a seismic survey. Hereinafter, a seismic survey may refer to a surface seismic survey, vertical seismic profile (VSP) survey, or checkshot survey. Further, seismic data may be collected during a surface seismic survey or VSP survey. In some embodiments, the first predicted traveltimes may be collected as a part of the seismic data. In other embodiments, the first predicted traveltimes and the seismic data may be collected at different times using the same or different type of survey.

FIG. 1 illustrates a surface seismic survey 100 in accordance with one or more embodiments. The surface seismic survey 100 is performed over a subterranean region of interest 105. The subterranean region of interest 105 may be made up of layers of rock 110 separated by geological boundaries 115 sometimes denoted horizons. The subterranean region of interest 105 may contain a hydrocarbon reservoir 120. The hydrocarbon reservoir 120 may be rock filled with fluid such as oil, gas, water, brine, or a combination thereof.

The surface seismic survey 100 may be used, at least in part, to identify structural features, like geological boundaries 115 and hydrocarbon reservoirs 120, within the subterranean region of interest 105. The surface seismic survey 100 may be performed using a seismic acquisition system 122. The seismic acquisition system 122 may include a seismic source 125 and seismic receivers 130 positioned on the surface of the earth 135.

The seismic source 125 may be configured to generate radiated seismic waves 140 (i.e., emitted energy, wavefield). The type of seismic source 125 may depend on the environment in which it is used. For example, on land, the seismic source 125 may be a vibroseis truck or explosive charge. In water, the seismic source 125 may be an airgun. The radiated seismic waves 140 may return to the surface of the earth 135 as refracted seismic waves (not shown) or may be reflected at geological boundaries 115 and return to the surface of the earth 135 as reflected seismic waves 145. The radiated seismic waves 140 may also propagate along the surface of the earth 135 as Rayleigh waves or Love waves, collectively known as surface waves 150 or “ground roll.” Vibrations associated with the surface waves 150 do not penetrate far beneath the surface of the earth 135 and, hence, are not influenced by, nor contain information about, portions of the subterranean region of interest 105 where hydrocarbon reservoirs 120 typically reside.

Seismic receivers 130 located on or near the surface of the earth 135 are configured to detect seismic waves. The time it takes for a seismic wave to propagate from the seismic source 125 to each seismic receiver 130 is denoted traveltime. Two-way traveltime may be determined from the surface seismic survey 100 as one or more seismic waves may propagate into the subterranean region of interest 105 (in one way), reflect at a geological boundary 115, hydrocarbon reservoir 120, or other structural feature, and propagate to each seismic receiver 130 (a second way).

Each seismic receiver 130 records a seismic trace. Each seismic trace may represent the amplitude of the ground motion caused by the seismic waves at a sequence of discrete times t beginning when the seismic waves are emitted from the seismic source 125. A change in amplitude within a seismic trace may occur at a time when seismic waves reflect at a structural feature within the subterranean region of interest 105. A change in amplitude may be referred to as a seismic event and considered a manifestation of a structural feature. Hereinafter, the terms “seismic event” and “manifestation of a structural feature” are considered synonymous and used interchangeably.

Assuming the position of the seismic source 125 and each seismic receiver 130 are denoted (xₛ, yₛ) and (xᵣ, yᵣ), respectively, where x and y represent orthogonal axes on the surface of the earth 135 above the subterranean region of interest 105, the collection of seismic traces collected during the surface seismic survey 100 may then be denoted S(xₛ, yₛ, xᵣ, yᵣ, t). Hereinafter, the collection of seismic traces is denoted the seismic data. The seismic data collected during the surface seismic survey 100 may be densely and regularly sampled.

Following the collection of the seismic data from the surface seismic survey 100, the seismic data or a portion of the seismic data may be used to determine a seismic velocity model. The seismic velocity model may be sparsely and/or irregularly sampled from the seismic data. The seismic velocity model may then be used to determine the first predicted traveltimes.

Similar methods used to perform the surface seismic survey 100 may be used to perform the VSP survey. The VSP survey may include multiple seismic sources 125. In some embodiments, the seismic sources 125 may be located on the surface of the earth 135 while the seismic receivers 130 are located downhole within a wellbore currently being or previously drilled within the subterranean region of interest 105. In other embodiments, the seismic receivers 130 may be located on the surface of the earth 135 while a drill bit drilling the wellbore acts as the seismic source 125. Types of VSP surveys include, but are not limited to, a zero-offset VSP survey, offset VSP survey, walkaway VSP survey, walk-above VSP survey, and seismic-while-drilling VSP survey. The VSP survey may determine one-way or two-way traveltimes. The seismic data collected during the VSP survey may be densely and regularly sampled.

Following the collection of the seismic data from the VSP survey, the seismic data or a portion of the seismic data may be used to determine the seismic velocity model. The seismic velocity model may be sparsely and/or irregularly sampled from the seismic data. The seismic velocity model may then be used to determine the first predicted traveltimes.

A checkshot survey may also determine the first predicted traveltimes. Here, the seismic source 125 may be deployed downhole within a wellbore at a known depth while the seismic receiver 130 is positioned on the surface of the earth 135 or vice versa. The checkshot survey may determine one-way traveltimes. The checkshot data collected during a checkshot survey may be sparsely and irregularly sampled. Further, in the context of this disclosure, the checkshot data may not be considered seismic data.

The seismic data collected during the surface seismic survey 100 or the VSP survey may be processed using a series of steps collectively referred to as seismic processing. The goal of seismic processing is to produce processed seismic data, typically in the form of a seismic image, that reasonably characterizes the subterranean region of interest 105. Structural features with the subterranean region of interest 105 may then be located using the seismic image. One or more seismic processing steps may correct for near-surface effects, suppress noise, correct for seismic survey geometry irregularities, enhance signal-to-noise ratio, migrate seismic events, convert between domains, etc. within the seismic data.

The processing step of migration may be applied to the seismic data to relocate one or more seismic events. One goal of migration is to relocate the one or more seismic events to each correspond or closely correspond to the true location of the associated structural feature within the subterranean region of interest 105. In some embodiments, migration may be applied to the seismic data if any of the seismic events are associated with a complex structural feature. Hereinafter, processed seismic data that has at least been migrated as a part of seismic processing is referred to as a migrated seismic image.

Migration, such as ray-based migration, may rely on a seismic velocity model to migrate one or more seismic events within the seismic data. The seismic velocity model may be determined from a portion of the seismic data. As such, this seismic velocity model may be a rough seismic velocity model that is sparsely sampled, irregularly sampled, and/or discontinuous. Use of this seismic velocity model during migration may propagate error to the migrated seismic image making the location of the seismic events inaccurate. In turn, the locations of the associated structural features within the subterranean region of interest 105 may be misidentified.

Inversion may be used to determine a smooth seismic velocity model from the seismic velocity model. Here, the term “smooth” may indicate that the smooth seismic velocity model is continuous and, thus, free of discontinuities. Use of the smooth seismic velocity model during migration may reduce the error propagated to the migrated seismic image making the location of the seismic events closer to the true locations of the associated structural features within the subterranean region of interest 105 relative to if a rough or poorly smoothed seismic velocity model is used.

The smooth seismic velocity model may be determined using inversion (i.e., solving the inverse problem). To solve the inverse problem, consider the linear system of equations:

$$Lm = d , \qquad Equation ( 1 )$$

where, in the context of this disclosure, L is a known matrix that may be denoted a forward-modeling operator or causal integration operator, d is a vector of the first predicted traveltimes, and m is the unknown smooth seismic velocity model. As previously mentioned, in some embodiments, the seismic velocity model may be sparsely sampled, irregularly sampled, and/or discontinuous. However, the smooth seismic velocity model m may be densely sampled, regularly sampled, and/or continuous. Note that Lm is a vector of the second predicted traveltimes determined from the smooth seismic velocity model m, both of which may be initially unknown. Further note that the inverse problem may be linearized by re-writing the unknown smooth seismic velocity model m as a function of slowness, which may be the inverse of velocity.

To solve the inverse problem means to determine the smooth seismic velocity model m where:

$$m = {L}^{- 1} d . \qquad Equation ( 2 )$$

However, Equations (1) and (2) may be considered ill posed as there may not be a unique solution for the smooth seismic velocity model m. As such, various methods may be used to iteratively or recursively approximate the smooth seismic velocity model m. Hereinafter, \hat{m} denotes an approximate smooth seismic velocity model that most closely satisfies Equations (1) and (2). While m denotes the smooth seismic velocity model and \hat{m} denotes the approximate smooth seismic velocity model, a person of ordinary skill in the art will appreciate that any discussion surrounding either m or \hat{m} may be replaced with the other, \hat{m} or m, without departing from the scope of the disclosure.

Methods used to determine the approximate smooth seismic velocity model \hat{m} may rely on a cost function. The term “cost function” may be synonymous to “error function,” “misfit function,” and “loss function.” In some embodiments, the cost function may be formulated as:

$${W}_{d} ( Lm - d ) , \qquad Equation ( 3 )$$

which includes a data residual weighting function W_{d} not previously included in Equations (1) and (2). The data residual weighting function W_{d} may be used for target-oriented smoothing. In other embodiments, the cost function may be formulated as Equation (3) and:

$$ϵ Dm . \qquad Equation ( 4 )$$

Equation (4) may be referred to as a regularization term where D may be denoted a regularization operator, roughing operator, derivative operator, or even a Tikhonov matrix and ∈ is a scalar scaling parameter that controls the strength of the regularization. A person of ordinary skill in the art will appreciate that regularization, in the context of this disclosure, may be considered a method of simplifying how to determine the smooth seismic velocity model m. As such, if regularization is implemented within inversion, the process may be referred to as regularized inversion. Note that regularization may not require the smooth seismic velocity model m to be regularly sampled.

The causal integration operator L may be designed based on the concept of kinematic equivalence or, more specifically, the concept of kinematically equivalent seismic velocity models. This concept may constrain Equations (1)-(3) such that the difference between the first predicted traveltimes d and the unknown second predicted traveltimes Lm determined from the unknown smooth seismic velocity model m are minimal. For example, consider a horizontally homogeneous model (that may represent a subterranean region of interest 105) where each first predicted traveltime dₖ among the first predicted traveltimes d are given by:

$${d}_{k} = {\sum }_{i = 1}^{k} \frac{Δ {z}_{i}}{{v}_{i}} , \qquad Equation ( 5 )$$

where i is a depth index that concludes at depth index k, vᵢ is the interval velocity at the depth index i, and Δzᵢ is the depth interval at the depth index i. If the interval velocity is evenly sampled along the depth axis, Δzᵢ is a constant that may simply be denoted Δz. By embedding Equation (5) into the causal integration operator L, L is now a function of d and constrains the smooth seismic velocity model m or the approximate smooth seismic velocity model \hat{m} with the goal of preserving the second predicted traveltimes relative to the first predicted traveltimes.

Returning to the cost functions presented in Equations (3) and (4), the least-squares norm may be used to extremize the cost functions to determine the approximate smooth seismic velocity model \hat{m}. The least-squares norm may be written as:

$${‖ {W}_{d} ( Lm - d ) ‖}_{2}^{2} + {‖ ϵ Dm ‖}_{2}^{2} \qquad Equation ( 6 )$$

where ∥·∥₂ is the Euclidean norm.

In some embodiments, the explicit solution to Equation (6) may take the form:

$$\hat{m} = {( {L}^{T} {W}_{d}^{T} {W}_{d} L + {ϵ}^{2} {D}^{T} D )}^{- 1} {L}^{T} {W}_{d}^{T} {W}_{d} d , \qquad Equation ( 7 )$$

if Tikhonov's regularization is used. In Equation (7), \hat{m} specifically denotes the least-squares estimate of the smooth seismic velocity model m and the superscript T denotes the adjoint operator.

Shaping regularization may be introduced to stabilize the inverse problem by including the shaping operator S within Equation (7) where:

$$S = {( I + {ϵ}^{2} {D}^{T} D )}^{- 1} , \qquad Equation ( 8 )$$

alternatively written as:

$${ϵ}^{2} {D}^{T} D = {S}^{- 1} - I , \qquad Equation ( 9 )$$

where I is the identity matrix. The shaping operator S is flexible. For example, the shaping operator S may be designed using, but not limited to, boxcar smoothing, triangle smoothing, and Gaussian smoothing. Additionally, the shaping operator S may be a dynamic structure-oriented shaping operator S such that the shaping operator S follows local structural features, such as dips, within the subterranean region of interest 105.

Substituting Equation (9) into Equation (7) yields:

$$\hat{m} = {( {L}^{T} {W}_{d}^{T} {W}_{d} L + {S}^{- 1} - I )}^{- 1} {L}^{T} {W}_{d}^{T} {W}_{d} d . \qquad Equation ( 10 )$$

As such, Equation (10) is regularized by shaping. The least-squares estimate of the smooth seismic velocity model \hat{m} in Equation (10) may be determined iteratively or recursively. Doing so may be referred to as solving the least-squares inverse problem. A variety of methods may be used to determine the least-squares estimate of the smooth seismic velocity model \hat{m}. Methods include, but are not limited to, a conjugate-gradient method, steepest descent method, and quasi-Newton method.

For example, if the conjugate-gradient method is used, symmetric positive-definite operators may be necessary. As such, Equation (10) may be symmetrized when the shaping operator S is symmetric and representable in the form S=HH^{T}, where H is square and invertible. Equation (10) then takes the form:

$$\hat{m} = {H [ {λ}^{2} I + {H}^{T} ( {L}^{T} {W}_{d}^{T} {W}_{d} L - {λ}^{2} I ) H ]}^{- 1} {H}^{T} {L}^{T} {W}_{d}^{T} {W}_{d} d , \qquad Equation ( 11 )$$

where L is being scaled by 1/λ where λ is a scalar scaling factor. The approximate smooth seismic velocity model \hat{m} may then be determined iteratively using Equation (11) and the conjugate-gradient method.

For each iteration, for any algorithm, an extremum (i.e., minimum or maximum) of the cost functions may be determined. The approximate smooth seismic velocity model \hat{m} may then be perturbed based on the extremum to determine an updated approximate smooth seismic velocity model \hat{m}. In the next iteration, the updated approximate smooth seismic velocity model \hat{m} is used to determine updated second predicted traveltimes L\hat{m} that may be used to form the updated cost functions W_{d}(L\hat{m}−d) and ∈D\hat{m}. Hereinafter, an updated approximate smooth seismic velocity model \hat{m} may be simply referred to as an updated smooth seismic velocity model.

Iterations may stop once a convergence criterion is satisfied. Convergence criteria may include, but are not limited to, reaching a pre-determined number of iterations, noting no appreciable change in the cost function between iterations, and reaching a pre-determined metric.

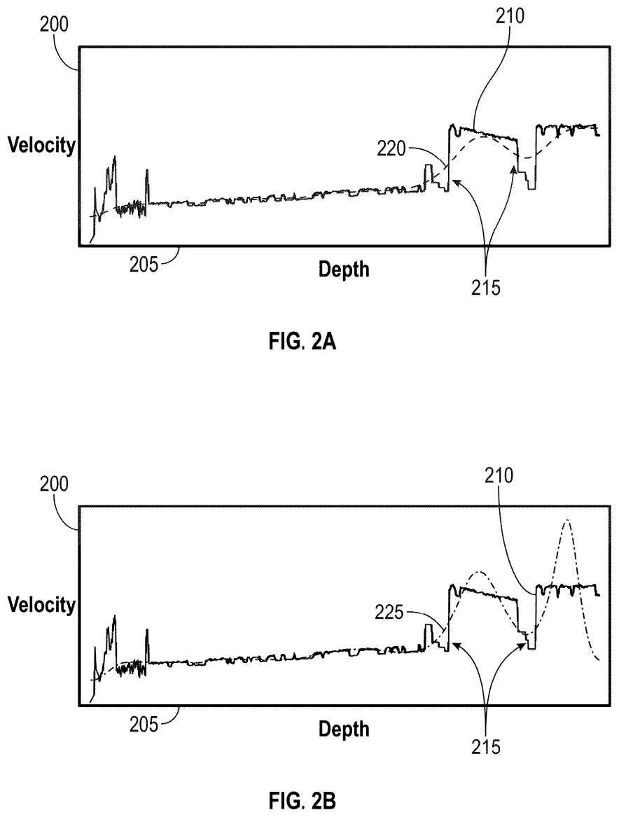

FIGS. 2A and 2B display one-dimensional (1D) seismic velocity models in accordance with one or more embodiments. Velocity is shown along the ordinates 200. Depth is shown along the abscissas 205. Both FIGS. 2A and 2B display a 1D true seismic velocity model 210. The 1D true seismic velocity model 210 includes discontinuities 215. FIG. 2A further displays a 1D Gaussian smooth seismic velocity model 220 determined using a conventional Gaussian smoothing method. FIG. 2B further displays a 1D updated smooth seismic velocity model 225 determined using the disclosed method.

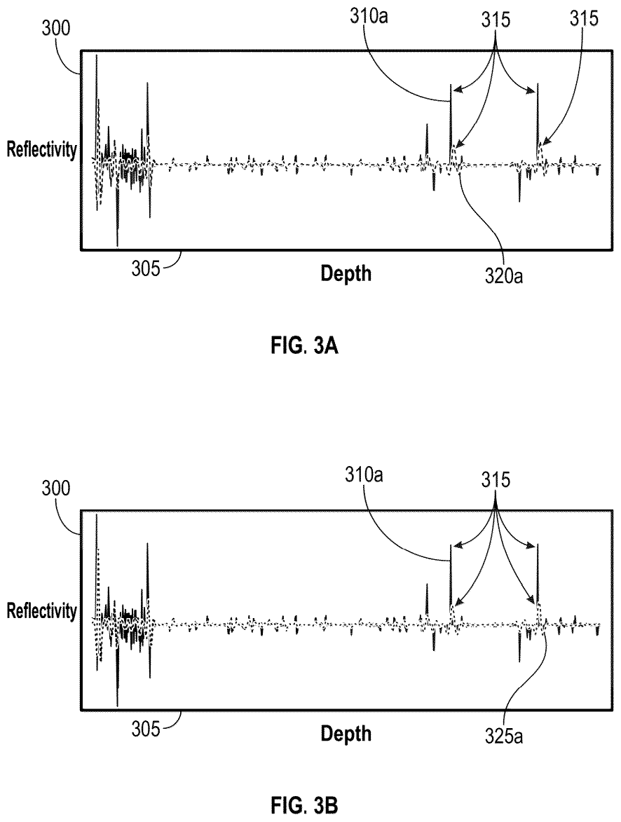

FIGS. 3A and 3B display 1D migrated seismic images in accordance with one or more embodiments. Reflectivity is shown along the ordinates 300. Depth is shown along the abscissas 305. Both FIGS. 3A and 3B display a 1D true migrated seismic image 310a where seismic events 315 may be correctly positioned. FIG. 3A further displays a 1D Gaussian migrated seismic image 320a determined using the 1D Gaussian smooth seismic velocity model 220 displayed in FIG. 2A By comparing the 1D true migrated seismic image 310a and the 1D Gaussian migrated seismic image 320a, use of the conventional Gaussian smoothing method may not constrain the second predicted traveltimes and, thus, migration may not relocate seismic events 315 to their true positions. FIG. 3B further displays a 1D migrated seismic image 325a determined using the 1D updated smooth seismic velocity model 225 displayed in FIG. 2B. By comparing the 1D true migrated seismic image 310a and the 1D migrated seismic image 325a, use of the disclosed methods may constrain the second predicted traveltimes and, thus, migration may relocate seismic events 315 to their true or nearly true positions.

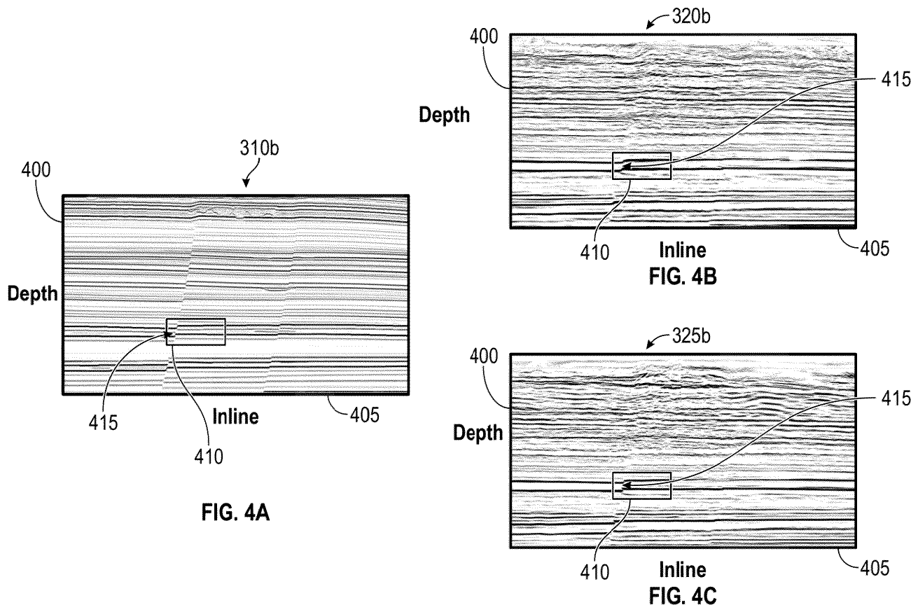

FIG. 4A displays a two-dimensional (2D) slice of the SEAM Arid model, which is a digital earth model. The SEAM Arid model may be considered a 2D true migrated seismic image 310b and is referred to as such hereinafter. FIG. 4B displays a 2D Gaussian migrated seismic image 320b determined using the conventional Gaussian smoothing method. FIG. 4C displays a 2D migrated seismic image 325b determined using the disclosed methods. Depth is shown along the ordinates 400. The inline axis is shown along the abscissas 405. FIGS. 4B and 4C each illustrate different methods of estimating the 2D slice of the true migrated seismic image 310b displayed in FIG. 4A. By comparing FIGS. 4A-4C, the migrated seismic image 325b provides a clearer and more accurate image, especially at deeper depths, than the Gaussian migrated seismic image 320b.

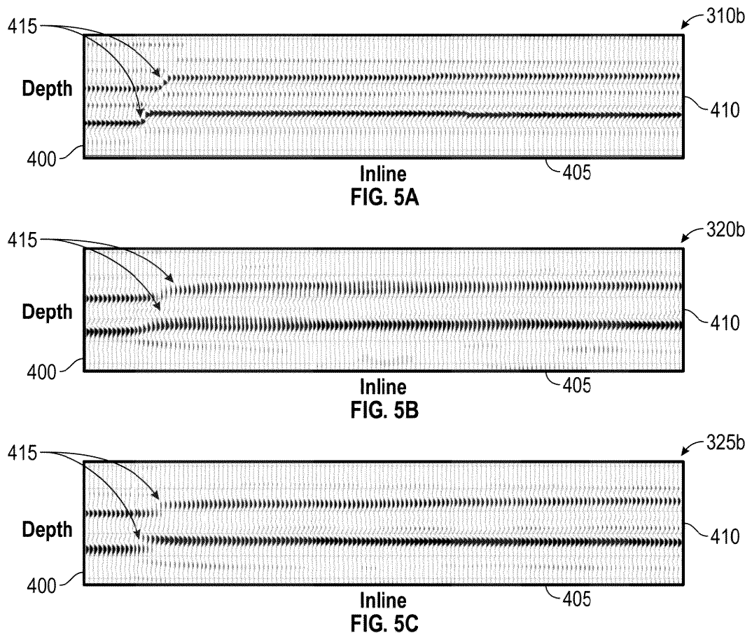

Each of FIGS. 4A-4C includes a box 410. Within the box 410 is a manifestation of a fault 415, which may be considered a complex structural feature. FIG. 5A displays the true migrated seismic image 310b displayed in FIG. 4A zoomed in within the box 410. The manifestation of the fault 415 is crisp and clear. FIG. 5B displays the Gaussian migrated seismic image 320b displayed in FIG. 4B zoomed in within the box 410. Now the manifestation of the fault 415 is blurred and unclear. As such, the conventional Gaussian smoothing method may not adequately characterize the subterranean region of interest 105. FIG. 5C displays the migrated seismic image 325b displayed in FIG. 4C zoomed in within the box 410. Now the manifestation of the fault 415 is crisp and clear. As such, the disclosed methods may adequately characterize the subterranean region of interest 105.

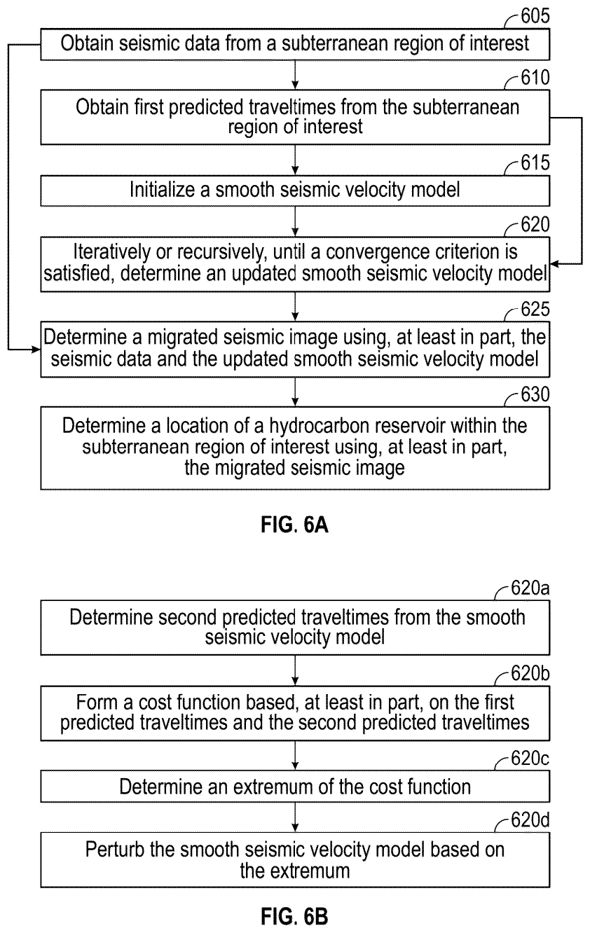

FIG. 6A shows a flowchart in accordance with one or more embodiments.

In step 605, seismic data is obtained from a subterranean region of interest 105. In some embodiments, the seismic data may be collected using a surface seismic survey 100 as described relative to FIG. 1 or VSP survey. In some embodiments, the seismic data may be densely sampled.

In step 610, the first predicted traveltimes d are obtained from the subterranean region of interest 105. Each first predicted traveltime dₖ among the first predicted traveltimes d correspond to a depth within the subterranean region of interest 105. In some embodiments, the first predicted traveltimes d may be vertical traveltimes.

In some embodiments, a checkshot survey may be used to obtain the first predicted traveltimes d separate from the seismic survey used to obtain the seismic data in step 605. In other embodiments, the surface seismic survey 100 as described relative to FIG. 1 may be used to obtain the seismic data that is used, at least in part, to determine a seismic velocity model and the seismic velocity model used to determine the first predicted traveltimes d. In still other embodiments, a VSP survey may be used to obtain the seismic data that is used, at least in part, to determine a seismic velocity model and the seismic velocity model used to determine the first predicted traveltimes d. The seismic velocity model may be a rough seismic velocity model. The seismic velocity model may be sparsely sampled, irregularly sampled, and/or discontinuous. A person of ordinary skill in the art will appreciate that the method used to obtain the first predicted traveltimes should in no way limit the present disclosure.

In step 615, a smooth seismic velocity model is initialized. The smooth seismic velocity model may be initialized using any method known to a person of ordinary skill in the art. Initialization methods may include, but are not limited to, assigning seismic velocity values randomly, based on a prescribed distribution, and based on the seismic velocity model discussed in step 610.

In step 620, an updated smooth seismic velocity model, such as updated smooth seismic velocity model 225, is determined iteratively or recursively. In some embodiments, the updated smooth seismic velocity model may be an approximate smooth seismic velocity model that updates after each iteration. Step 620 may be performed by iteratively applying the conjugate-gradient method, steepest descent method, or quasi-Newton method to Equation (10) or (11). Step 620 is described in detail relative to FIG. 6B.

In step 625, a migrated seismic image, such as migrated seismic images 325a-b, is determined using, at least in part, the updated smooth seismic velocity model determined in step 620 and the seismic data obtained in step 605. In some embodiments, seismic processing steps other than just migration may be applied to the seismic data to correct for near-surface effects, suppress noise, correct for seismic survey geometry irregularities, enhance signal-to-noise ratio, convert between domains, etc. Further, a person of ordinary skill in the art will appreciate that any method of migration may be used to determine the migrated seismic image at any point within seismic processing. Migration methods may include, but are not limited to, Kirchhoff time migration, Kirchhoff depth migration, wave-equation migration, reverse time migration, least-squares reverse time migration, and beam migration.

In step 630, a location of a hydrocarbon reservoir 120 within the subterranean region of interest 105 is determined using, at least in part, the migrated seismic image.

In some embodiments, a wellbore path may be planned that penetrates the hydrocarbon reservoir 120. In some embodiments, a wellbore may then be drilled guided by the planned wellbore path. The wellbore may ultimately penetrate the hydrocarbon reservoir 120.

FIG. 6B describes step 620 mentioned in FIG. 6A. Recall that in step 620 the updated smooth seismic velocity model is determined iteratively or recursively. Steps 620a-d may be performed to determine the updated smooth seismic velocity model, which may be an approximate smooth seismic velocity model \hat{m}. In step 620a, the second predicted traveltimes L\hat{m} are determined from the smooth seismic velocity model \hat{m}. If the first iteration is being performed, the smooth seismic velocity model \hat{m} may be the smooth seismic velocity model \hat{m} initialized in step 615. If any other iteration is being performed, the smooth seismic velocity model \hat{m} may be the perturbed smooth seismic velocity model \hat{m} determined in the previous iteration.

In step 620b, one or more cost functions are formed, based at least in part, on the first predicted traveltimes d obtained in step 610 and the second predicted traveltimes L\hat{m} determined in step 620a. In some embodiments, the cost function may look similar to Equation (3), though the cost function may or may not include the data residual weighting function W_{d}. In other embodiments, the cost function may look similar to Equations (3) and (4), though the cost function may or may not include the data residual weighting function W_{d} or the scalar scaling parameter E. A person of ordinary skill in the art will appreciate that other cost functions that include additional terms and/or operators or exclude terms and/or operators may be used without departing from the scope of the disclosure.

In step 620c, an extremum (i.e., a minimum or maximum) of the cost function is determined. The extremum may be a measure of how similar the second predicted traveltimes L\hat{m} are relative to the first predicted traveltimes d.

In step 620d, the smooth seismic velocity model \hat{m} is perturbed based on the extremum. In some embodiments, the smooth seismic velocity model \hat{m} may be perturbed with the goal of decreasing the extremum in which cases the second predicted traveltimes L\hat{m} are updated to be more similar to the first predicted traveltimes d.

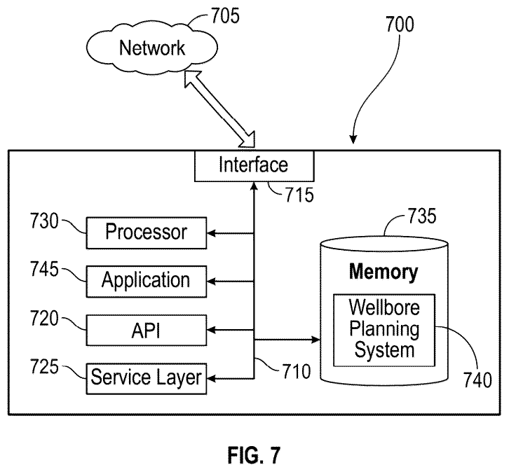

Turning to systems, FIG. 7 illustrates a generic computer system 700 in accordance with one or more embodiments. The computer system 700 (hereinafter also “computer”) may be specifically configured for seismic processing and denoted a “seismic processing system.” The seismic processing system may be configured to perform steps 605, 610, 615, 620 (including 620a-d), and 625. Alternatively, the computer 700 may be specifically configured for seismic interpretation and denoted a “seismic interpretation workstation.” The seismic interpretation system may be configured to perform step 630. While the generic term “computer” or “computer system” may be used to describe the parts of a computer 700 in the following paragraphs, the terms “seismic processing system” or “seismic interpretation workstation” may replace the term “computer” or “computer system” without departing from the scope of the disclosure.

The computer 700 is intended to depict any computing device such as a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, the computer 700 may include an input device, such as a keypad, keyboard, touch screen, or other device that can accept user information, and an output device that displays information, including digital data, visual or audio information (or a combination of both), or a graphical user interface (GUI). Specifically, a seismic interpretation workstation may include a robust graphics card for the detailed rendering of a migrated seismic image such that the migrated seismic image may be displayed and manipulated in a virtual reality system using 3D goggles, a mouse, or a wand.

The computer 700 can serve in a role as a client, network component, server, database, or any other component (or a combination of roles) of a computer system 700 as required for seismic processing and seismic interpretation. The illustrated computer system 700 is communicably coupled with a network 705. For example, a seismic processing system and a seismic interpretation workstation may be communicably coupled using the network 705. In some implementations, one or more components of each computer system 700 may be configured to operate within environments, including cloud-computing-based, local, global, or other environment (or a combination of environments).

At a high level, the computer system 700 is an electronic computing device operable to receive, transmit, process, store, and/or manage data and information associated with seismic processing and seismic interpretation. According to some implementations, the computer system 700 may also include or be communicably coupled with an application server, e-mail server, web server, caching server, streaming data server, business intelligence (BI) server, or other server (or a combination of servers).

Because seismic processing and seismic interpretation may not be sequential, the computer system 700 can receive requests over network 705 from other computer systems 700 or another client application and respond to the received requests by processing the requests appropriately. In addition, requests may also be sent to the computer system 700 from internal users (for example, from a command console or by other appropriate access method), external or third-parties, other automated applications, as well as any other appropriate entities, individuals, systems, or computer systems 700.

Each of the components of the computer system 700 can communicate using a system bus 710. In some implementations, any or all of the components of each computer system 700, both hardware or software (or a combination of hardware and software), may interface with each other or the interface 715 (or a combination of both) over the system bus 710 using an application programming interface (API) 720 or a service layer 725 (or a combination of the API 720 and service layer 725). The API 720 may include specifications for routines, data structures, and object classes. The API 720 may be either computer-language independent or dependent and refer to a complete interface, a single function, or even a set of APIs 720. The service layer 725 provides software services to each computer system 700 or other components (whether or not illustrated) that are communicably coupled to each computer system 700. The functionality of each computer system 700 may be accessible for all service consumers using this service layer 725. Software services, such as those provided by the service layer 725, provide reusable, defined business functionalities through a defined interface. For example, the interface may be software written in JAVA, C++, or other suitable language providing data in extensible markup language (XML) format or another suitable format. While illustrated as an integrated component of each computer system 700, alternative implementations may illustrate the API 720 or the service layer 725 as stand-alone components in relation to other components of each computer system 700 or other components (whether or not illustrated) that are communicably coupled to each computer system 700. Moreover, any or all parts of the API 720 or the service layer 725 may be implemented as child or sub-modules of another software module, enterprise application, or hardware module without departing from the scope of this disclosure.

The computer system 700 includes an interface 715. Although illustrated as a single interface 715 in FIG. 7, two or more interfaces 715 may be used according to particular needs, desires, or particular implementations of each computer system 700. The interface 715 is used by each computer system 700 for communicating with other systems in a distributed environment that are connected to the network 705. Generally, the interface 715 includes logic encoded in software or hardware (or a combination of software and hardware) and operable to communicate with the network 705. More specifically, the interface 715 may include software supporting one or more communication protocols associated with communications such that the network 705 or interface's hardware is operable to communicate physical signals within and outside of the illustrated computer 700.

The computer system 700 includes at least one computer processor 730. Generally, a computer processor 730 executes any instructions, algorithms, methods, functions, processes, flows, and procedures as described above. A computer processor 730 may be a central processing unit (CPU) and/or a graphics processing unit (GPU). The seismic data may be hundreds of terabytes in size. To efficiently process the seismic data, a seismic processing system may consist of an array of CPUs with one or more subarrays of GPUs attached to each CPU. Further, tape readers or high-capacity hard-drives may be connected to the CPUs using wide-band system buses.

The computer system 700 also includes a memory 735 that stores data and software for the computer system 700 or other components (or a combination of both) that can be connected to the network 705. For example, the memory 735 may store a wellbore planning system 740 in the form of software. Although illustrated as a single memory 735 in FIG. 7, two or more memories 735 may be used according to particular needs, desires, or particular implementations of the computer system 700 and the described functionality. While memory 735 is illustrated as an integral component of each computer system 700, in alternative implementations, memory 735 can be external to each computer system 700.

The application 745 is an algorithmic software engine providing functionality according to particular needs, desires, or particular implementations of the computer system 700, particularly with respect to functionality described in this disclosure. For example, application 745 can serve as one or more components, modules, applications, etc. Further, although illustrated as a single application, the application may be implemented as multiple applications on each computer system 700. In addition, although illustrated as integral to each computer system 700, in alternative implementations, the application 745 can be external to each computer system 700.

There may be any number of computers 700 associated with, or external to, a seismic processing system and a seismic interpretation workstation, where each computer system 700 communicates over network 705. Further, the term “client,” “user,” and other appropriate terminology may be used interchangeably as appropriate without departing from the scope of this disclosure. Moreover, this disclosure contemplates that many users may use the computer system 700 or that one user may use multiple computer systems 700.

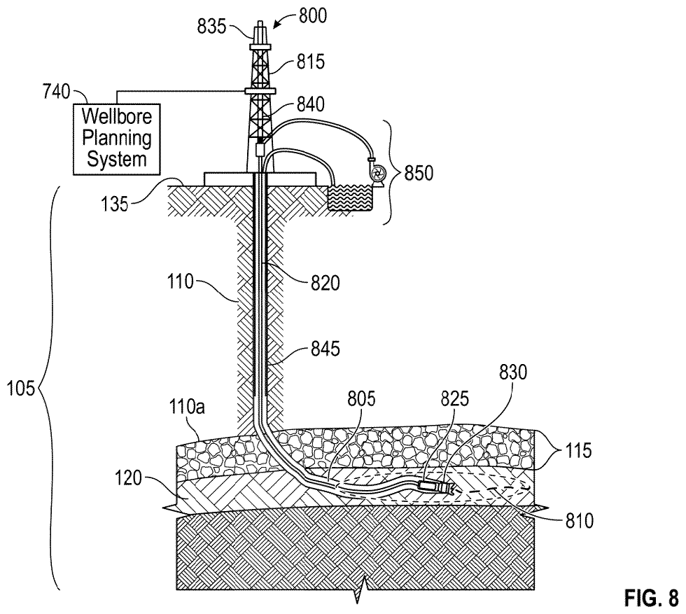

Continuing with systems, FIG. 8 illustrates a drilling system 800 in accordance with one or more embodiments. A wellbore 805 may be drilled, using the drilling system 800, guided by the planned wellbore path 810 to penetrate the hydrocarbon reservoir 120. Although the drilling system 800 shown in FIG. 8 is used to drill the wellbore 805 on land, the drilling system 800 may also be a marine wellbore drilling system. The example of the drilling system 800 shown in FIG. 8 is not meant to limit the present disclosure.

As shown in FIG. 8, the wellbore 805 may be drilled using a drill rig that may be situated on a land drill site, an offshore platform, such as a jack-up rig, a semi-submersible, or a drill ship. The drill rig may be equipped with a hoisting system, such as a derrick 815, which can raise or lower the drillstring 820 and other tools required to drill the wellbore 805. The drillstring 820 may include one or more drill pipes connected to form conduit and a bottom hole assembly 825 (BHA) disposed at the distal end of the drillstring 820. The BHA 825 may include a drill bit 830 to cut into rock 110, including cap rock 110a. The BHA 825 may further include measurement tools, such as a measurement-while-drilling (MWD) tool and logging-while-drilling (LWD) tool. MWD tools may include sensors and hardware to measure downhole drilling parameters, such as the azimuth and inclination of the drill bit 830, the weight-on-bit, and the torque. The LWD measurements may include sensors, such as resistivity, gamma ray, and neutron density sensors, to characterize the rock 110 surrounding the wellbore 805. Both MWD and LWD measurements may be transmitted to the surface of the earth 135 using any suitable telemetry system known in the art, such as a mud-pulse or by wired-drill pipe.

To start drilling, or “spudding in,” the wellbore 805, the hoisting system lowers the drillstring 820 suspended from the derrick 815 towards the planned surface location of the wellbore 805. An engine, such as a diesel engine, may be used to supply power to the top drive 835 to rotate the drillstring 820 via the drive shaft 840. The weight of the drillstring 820 combined with the rotational motion enables the drill bit 830 to bore the wellbore 805.

The near-surface of the subterranean region of interest 105 is typically made up of loose or soft sediment or rock 110, so large diameter casing 845 (e.g., “base pipe” or “conductor casing”) is often put in place while drilling to stabilize and isolate the wellbore 805. At the top of the base pipe is the wellhead, which serves to provide pressure control through a series of spools, valves, or adapters (not shown). Once near-surface drilling has begun, water or drill fluid may be used to force the base pipe into place using a pumping system until the wellhead is situated just above the surface of the earth 135.

Drilling may continue without any casing 845 once deeper or more compact rock 110 is reached. While drilling, a drilling mud system 850 may pump drilling mud from a mud tank on the surface of the earth 135 through the drill pipe. Drilling mud serves various purposes, including pressure equalization, removal of rock cuttings, and drill bit cooling and lubrication.

At planned depth intervals, drilling may be paused and the drillstring 820 withdrawn from the wellbore 805. Sections of casing 845 may be connected and inserted and cemented into the wellbore 805. Casing string may be cemented in place by pumping cement and mud, separated by a “cementing plug,” from the surface of the earth 135 through the drill pipe. The cementing plug and drilling mud force the cement through the drill pipe and into the annular space between the casing 845 and the wall of the wellbore 805. Once the cement cures, drilling may recommence. The drilling process is often performed in several stages. Therefore, the drilling and casing cycle may be repeated more than once, depending on the depth of the wellbore 805 and the pressure on the walls of the wellbore 805 from surrounding rock 110.

Due to the high pressures experienced by deep wellbores 805, a blowout preventer (BOP) may be installed at the wellhead to protect the rig and environment from unplanned oil or gas releases. As the wellbore 805 becomes deeper, both successively smaller drill bits 830 and casing 845 may be used. Drilling deviated or horizontal wellbores 805 may require specialized drill bits 830 or drill assemblies.

The drilling system 800 may be disposed at and communicate with other systems in the wellbore environment. The drilling system 800 may control at least a portion of a drilling operation by providing controls to various components of the drilling operation. In one or more embodiments, the system may receive data from one or more sensors arranged to measure controllable parameters of the drilling operation. As a non-limiting example, sensors may be arranged to measure weight-on-bit, drill rotational speed (RPM), flow rate of the mud pumps (GPM), and rate of penetration of the drilling operation (ROP). Each sensor may be positioned or configured to measure a desired physical stimulus. Drilling may be considered complete when a drilling target with the hydrocarbon reservoir 120 is reached or the presence of hydrocarbons is established.

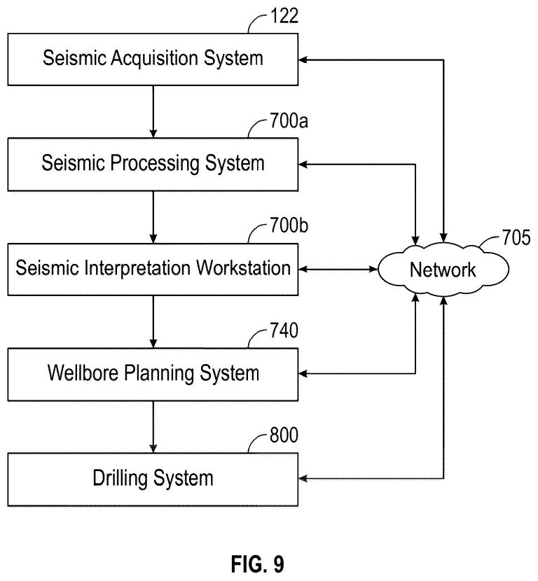

FIG. 9 illustrates a workflow of systems in accordance with one or more embodiments that may be used to perform the previously described methods. In some embodiments, one or more seismic acquisition systems 122 may be configured to collect the seismic data and the first predicted traveltimes from the subterranean region of interest 105 by performing a surface seismic survey 100, VSP survey, and/or checkshot survey. In some embodiments, a seismic acquisition system 122 may be configured to obtain the seismic data from the subterranean region of interest 105 by performing a surface seismic survey 100 or VSP survey. In some embodiments, different seismic acquisition systems may be configured to obtain the first predicted traveltimes and the seismic data independently of one another. In other embodiments, one seismic acquisition system 122 may be configured to obtain the first predicted traveltimes and the seismic data at the same time.

The first predicted traveltimes and seismic data may be input into, stored on, and processed using the seismic processing system 700a to determine the updated smooth seismic velocity model, such as the updated smooth seismic velocity model 225, and the migrated seismic image, such as the migrated seismic images 325a-b.

The migrated seismic image may be transferred to and stored on the seismic interpretation workstation 700b via the network 705 as described relative to FIG. 7. The migrated seismic image may then be displayed on the seismic interpretation workstation 700b. A seismic interpreter may then manually manipulate the migrated seismic image using the seismic interpretation workstation 700b to identify and label the location of the manifestation of the hydrocarbon reservoir 120.

The labeled migrated seismic image may then be loaded into the wellbore planning system 740 that may be located on the memory 735 of the computer system 700. A user of the computer system 700 may use the migrated seismic image loaded into the wellbore planning system 740 to plan the wellbore path 810 that penetrates the hydrocarbon reservoir 120.

The planned wellbore path 810 may be loaded into the drilling system 800 discussed in reference to FIG. 8. The drilling system 800 may be configured to drill the wellbore 805 within the subterranean region of interest 105 guided by the planned wellbore path 810. Following drilling and completion of the wellbore 805, the wellbore 805 may be used to produce hydrocarbons from the hydrocarbon reservoir 120 to the surface of the earth 135.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed is:

1. A method comprising:
obtaining seismic data from a subterranean region of interest;
obtaining first predicted traveltimes from the subterranean region of interest;
initializing a smooth seismic velocity model;
iteratively or recursively, until a convergence criterion is satisfied, determining an updated smooth seismic velocity model comprising:
determining second predicted traveltimes from the smooth seismic velocity model,
forming a cost function based, at least in part, on the first predicted traveltimes and the second predicted traveltimes,
determining an extremum of the cost function, and
perturbing the smooth seismic velocity model based on the extremum;
determining a migrated seismic image using, at least in part, the seismic data and the updated smooth seismic velocity model; and
determining a location of a hydrocarbon reservoir within the subterranean region of interest using, at least in part, the migrated seismic image.

2. The method of claim 1, further comprising planning, using a wellbore planning system, a wellbore path that penetrates the hydrocarbon reservoir.

3. The method of claim 2, further comprising drilling, using a drilling system, a wellbore guided by the planned wellbore path.

4. The method of claim 1, wherein the seismic data comprises the first predicted traveltimes.

5. The method of claim 1, wherein the first predicted traveltimes comprise first predicted vertical traveltimes.

6. The method of claim 1, wherein the cost function comprises a least-squares cost function.

7. The method of claim 1, wherein the cost function comprises a causal integration operator.

8. The method of claim 7, the causal integration operator is a function of the first predicted traveltimes.

9. The method of claim 1, wherein the cost function comprises a weighting operator.

10. The method of claim 1, wherein the cost function comprises a shaping operator.

11. The method of claim 10, wherein the shaping operator comprises a dynamic shaping operator.

12. The method of claim 1, wherein determining the updated smooth seismic velocity model comprises applying a conjugate-graduate method to the cost function.

13. A system comprising:
a seismic processing system configured to:
receive seismic data from a subterranean region of interest,
receive first predicted traveltimes from the subterranean region of interest,
initialize a smooth seismic velocity model,
iteratively or recursively, until a convergence criterion is satisfied, determine an updated smooth seismic velocity model comprising:
determine second predicted traveltimes from the smooth seismic velocity model;
form a cost function based, at least in part, on the first predicted traveltimes and the second predicted traveltimes;
determine an extremum of the cost function; and
perturb the smooth seismic velocity model based on the extremum, and
determine a migrated seismic image using, at least in part, the seismic data and the updated smooth seismic velocity model; and
a seismic interpretation workstation configured to:
determine a location of a hydrocarbon reservoir within the subterranean region of interest using, at least in part, the migrated seismic image.

14. The system of claim 13, further comprising a wellbore planning system configured to plan a wellbore path that penetrates the hydrocarbon reservoir.

15. The system of claim 14, further comprising a drilling system configured to drill a wellbore guided by the planned wellbore path.

16. The system of claim 13, further comprising a seismic acquisition system configured to obtain the seismic data.

17. A non-transitory computer-readable memory having computer-executable instructions stored thereon that, when executed by a computer processor, perform steps comprising:
receiving seismic data from a subterranean region of interest;
receiving first predicted traveltimes from the subterranean region of interest;
initializing a smooth seismic velocity model;
iteratively or recursively, until a convergence criterion is satisfied, determining an updated smooth seismic velocity model comprising:
determining second predicted traveltimes from the smooth seismic velocity model,
forming a cost function based, at least in part, on the first predicted traveltimes and the second predicted traveltimes,
determining an extremum of the cost function, and
perturbing the smooth seismic velocity model based on the extremum;
determining a migrated seismic image using, at least in part, the seismic data and the updated smooth seismic velocity model; and
determining a location of a hydrocarbon reservoir within the subterranean region of interest using, at least in part, the migrated seismic image.

18. The non-transitory computer-readable memory of claim 17, wherein the cost function comprises determining a least-squares cost function.

19. The non-transitory computer-readable memory of claim 17, wherein the cost function comprises a shaping operator.

20. The non-transitory computer-readable memory of claim 17, wherein determining the updated smooth seismic velocity model comprises applying a conjugate-graduate method to the cost function.
